(19) United States
(12) Patent Application Publication
(10) Pub. No.: US 2006/0039075 A1
(43) Pub. Date: Feb. 23, 2006

(54) Method for editing of a digital film using an electronic data processing apparatus

(75) Inventor: Joachim Kleine, Augsburg (DE)

Correspondence Address: COHEN, PONTANI, LIEBERMAN & PAVANE;Suite 1210, 551 Fifth Avenue, New York, NY, 10176, US

(73) Assignee: Fujitsu Siemens Computers GmbH, Munich (DE)

(21) Appl. No.: 11/209,400

(22) Filed: Aug. 22, 2005

(30) Foreign Application Priority Data
Aug. 20, 2004 (DE) 10 2004 040 541.7

(51) Int. Cl. G11B 27/02

(52) U.S. Cl. 360/13

(57) ABSTRACT

A method for editing a digital film using an electronic data processing apparatus, comprising the steps of: setting a first editing mark; setting a second editing mark; and deleting a film section between the first editing mark and the second editing mark. At least one of the steps of setting the first and second editing marks comprises the following steps performed in sequence by the electronic data processing apparatus: (a) during a replay mode, responding to manual actuation of a key by setting the editing mark at a first point on the digital film; (b) automatically making a backward jump from the first point on the digital film to an earlier point on the digital film; (c) automatically initiating a continuation of the replay mode at the earlier point on the film reached by the backward jump; and (d) in response to another manual actuation of the key, which is made when said first point is at an unsatisfactory location on the digital film, setting the editing mark at a second point on the digital film during continuation of the replay mode.

### RELATED APPLICATION

This patent application claims the priority of German patent application 10 2004 040 541.7, filed Aug. 20, 2004, the disclosure content of which is hereby incorporated by reference.

### FIELD OF THE INVENTION

The invention relates to a method for editing of a digital film using an electronic data processing apparatus, having the steps of setting a first editing mark, setting a second editing mark, and deleting a film section between the first editing mark and the second editing mark. The invention also relates to an editing apparatus for editing of a digital film, having a data processing apparatus and a remote control.

### BACKGROUND OF THE INVENTION

Films are evermore frequently put in digital form. The processing of films in digital form has been made possible by the availability of digital storage media with a large recording capacity at relatively low prices. Furthermore, microprocessors are available that can process large amounts of data, such as those which occur in films, in real time.

As in the case of films which are in analog form, films which are in digital form are subject to the problem that film sections are often recorded which are actually not desired. By way of example, in the case of private video recordings, only a small number of scenes are often suitable for being viewed later. For example, when films that have been transmitted by television are recorded, the advertising which is automatically recorded at the same time is undesired. Furthermore, in the case of timer-controlled automatic recording, it is possible for the recording to start too early, that is to say before the start of the film, and it is also possible for the recording not to end until a time period after the end of the film. In all of these situations, it is desirable to have a capability to edit out the undesired film sections. While, by way of example, this could be done only with great difficulty in the case of analog video cassettes, and the editing process is also associated with loss of quality, films that are in digital form can be edited without any loss of quality.

Editing systems for digital films are frequently in the form of computer programs, so that the conventional, convenient computer control process using a mouse and keyboard can be used in order to define the film sections to be edited out.

Digital recorders which, for example, use a hard disk as the storage medium, are increasingly being used in the users' living rooms, and are positioned in the vicinity of the television, in the same way as a video recorder or satellite receiver. They often also have an editing function. Appliances such as these have neither a mouse nor a keyboard, but are operated using a remote control. Considerably fewer control elements are thus available than in the case of conventional computer-based editing systems.

When using a remote control for operation, it is problematic to precisely set editing marks within a film to be edited. An editing mark is typically set by pushing a key. The problem in this case is that a certain amount of time passes between identification of the point at which editing is intended to be carried out and the pressing of the key. Overall, this means that the editing marks are always set too late, that is to say not at the correct point.

### SUMMARY OF THE INVENTION

One object of the invention is to provide a method for editing of a digital film, in which it is easier to set an exact editing mark. Another object is to provide an appropriate editing apparatus.

These and other objects are attained in accordance with one aspect of the present invention directed to a method for editing a digital film using an electronic data processing apparatus, comprising the steps of: setting a first editing mark, setting a second editing mark; and deleting a film section between the first editing mark and the second editing mark. At least one of the steps of setting the first and second editing marks comprises the following steps performed in sequence by the electronic data processing apparatus: (a) during a replay mode, responding to manual actuation of a key by setting the editing mark at a first point on the digital film, (b) automatically making a backward jump from the first point on the digital film to an earlier point on the digital film, (c) automatically initiating a continuation of the replay mode at the earlier point on the film reached by the backward jump; and (d) in response to another manual actuation of the key, which is made when said first point is at an unsatisfactory location on the digital film, setting the editing mark at a second point on the digital film during continuation of the replay mode.

With respect to the editing apparatus, the object is achieved by an editing apparatus of the type mentioned initially, having a data processing apparatus that is designed to carry out the above-described method, and the key is a key on the remote control.

One advantage of the method according to the invention and of the editing apparatus according to the invention is that it is possible to set the editing marks more accurately without requiring a large number of keys, nor are input aids such as a mouse or the like, required for this purpose. A single key on the remote control is sufficient to set the editing mark at precisely that position at which it is desired. The process of carrying out the backward jump and continuing the replay mode automatically allows the user to concentrate entirely on the position of the editing mark, without being distracted by searching for the correct keys for reversing and for switching to the replay mode. This is particularly advantageous when the editing apparatus or the method is used in conjunction with a television, which is often used in poor lighting conditions in the living room.

Since the method according to the invention can be carried out repeatedly, this makes it possible to progressively approach the desired editing point.

It is advantageous for a slowed-down variant of the replay mode to be carried out after a backward jump. This makes it even easier to reliably set an editing mark positioned at an exact time.

It is advantageous for different keys to be used for setting the first and the second editing marks. If appropriate color markings are used on the keys, this provides the user with greater confidence that he will not edit out the incorrect film section.

Furthermore, it is advantageous for a connected display unit to be used to indicate whether the currently running film section is before the first editing mark, after the second editing mark, or between the two editing marks.

### BRIEF DESCRIPTION OF THE DRAWINGS

FIG. 1 shows an editing apparatus for carrying out the method according to the invention,

FIG. 2 shows a flowchart of a first embodiment of a method according to the invention,

FIG. 3 shows a flowchart of a second embodiment of the method according to the invention, and

FIG. 4 shows a timing diagram in order to illustrate the timings for carrying out the methods according to the invention.

### DETAILED DESCRIPTION OF THE DRAWINGS

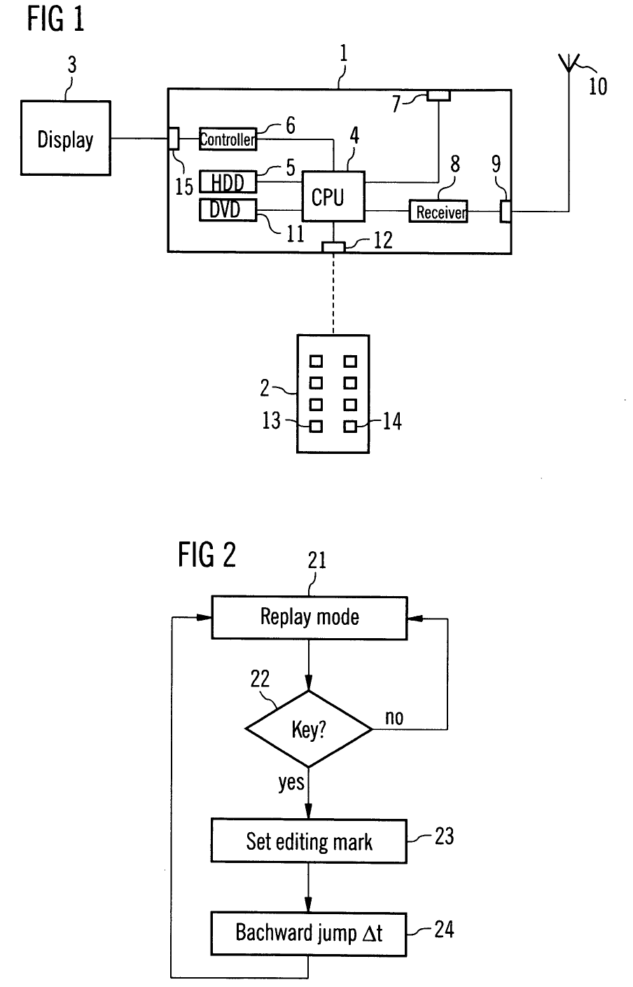

FIG. 1 shows an editing apparatus having a data processing apparatus 1 and a remote control 2. In the arrangement shown in FIG. 1, a display unit 3 is also connected to the editing apparatus.

The data processing apparatus 1 has a computation unit 4, which is provided for processing the data that arises. The computation unit 4 is connected to a hard disk memory 5, which is provided for storage of digital films. Furthermore, the application software required for operation and an operating system are stored there. In addition, a display control unit 6 is provided, and is designed to control the display unit 3. The display control unit 6 is preferably designed in such a way that it can control various types of display units, for example a computer monitor or a television. A suitable interface 15 is provided for connection of the display units.

There are a number of possible data sources for the digital films. On the one hand, it is possible to receive television programs via an antenna from a terrestrial transmitter, via a satellite receiver or via a cable connection. An RF processing unit 8 is provided for this purpose. By way of example, FIG. 1 shows an antenna 10 connected to an interface 9 which is associated with this RF processing unit 8. In addition, it is possible to receive data via a digital interface 7, to which, by way of example, a digital video camera (not shown) can be connected. A third option is to read a digital film from a rewriteable data storage medium. A DVD drive 11 is provided for this purpose, and is preferably designed such that data cannot only be read from but can also be written to the rewriteable data storage medium. Further options for the connection of data sources result from the flexible design concept.

The computation unit 4 is connected to an interface 12 which allows wire-free communication with a remote control 2. At least some of the functions of the data processing apparatus 1 can be controlled via the remote control 2. Keys on the remote control can be permanently associated with functions of the data processing apparatus, or else a control process can be carried out using a menu, which is displayed on the connected display unit 3, via the computation unit 4 and the display control unit 6. The keys on the remote control 2 can be used to open menus, to navigate within the menu, and to select instructions or settings.

One of the most important functions of the described arrangement is the editing of digital films. Fundamentally, this is done by setting a first editing mark while viewing the film to be edited, which first editing mark identifies the start of the film section to be edited out, and by setting a further editing mark while continuing to view the film, identifying the end of the film section to be edited out. When the two editing marks have been set, the film section between the first and the second editing mark is deleted. In order to achieve a good editing result, it is necessary for the editing marks to be set as precisely as possible, so that in fact only those parts of the film which are not desired are edited out. On the other hand, those parts of the film which should actually be retained should not also be edited out.

In order to accomplish this task, previous editing apparatuses have had a plurality of keys for controlling the running of the film. By pressing a replay key on the remote control, the film is output on the display unit 3, starting from a current position. Furthermore, keys are provided for fast forward and reverse. Two keys are likewise also provided for setting the first and the second editing marks. These keys can also be provided on the remote control 2 of the editing apparatus according to the invention.

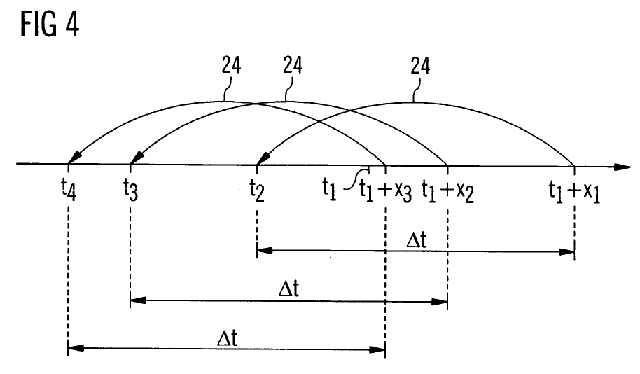

The following explanatory notes relate to the setting of the first editing mark, but they can be transferred analogously to the setting of the second editing mark. When viewing the film that is running, a user identifies that a film section to be edited out starts at a specific point t1, for example with this being an advertising block embedded in a movie (with regard to the times mentioned, see also the diagram in FIG. 4). Typically, a few seconds pass between the identification of the start of the advertising block at the time t1 and the pushing of the key at the time t1+x1, by means of which the first editing mark is set. This time is required to pick up the remote control, to find the correct key, and to press it. This leads to the editing mark being set too late. In order to position the editing mark at a more appropriate point, a user has to reverse the film, operating the appropriate key for fast reverse to do so. He must then switch to the replay mode in order once again to reach the point at which the advertising block starts. This process may have to be repeated several times before the first editing mark is positioned sufficiently exactly.

The method according to the invention for simplification of the setting of editing marks is illustrated in the flowchart in FIG. 2. Starting from a replay mode (step 21), monitoring is carried out to determine whether a key for setting an editing mark has been pressed on the remote control (step 22). The replay mode remains selected for as long as this is not the case. When the key is pressed, the editing mark is set (step 23). Without the user having to operate any further keys, a backward jump is automatically made in the next step 24 by a predetermined time period Δt, for example three seconds. The editing apparatus then automatically switches to the replay mode (step 21), so that the user can check whether or not the editing mark that has been set is appropriate.

As stated above, the editing mark is generally set too late. When the user returns to the time t1 in the replay mode at the start of the advertising block mentioned above by way of example, then he is already expecting this advertising block to start, has the remote control in his hand and is waiting for the time when he has to press the key in order to set the editing mark. He will therefore react more quickly at the start of the advertising block, so that the editing mark is set at a considerably more appropriate time t1+x2. The backward jump by the predetermined time period Δt (step 24) then once again takes place automatically, followed by automatic switching to the replay mode (step 21), so that the user can check the position of the editing mark that has been set by observing an appropriate indicator of a connected display. This process is repeated as often as desired, and also covers the situation in which the editing mark has been set too early. As part of this process, a previously set editing mark can be deleted when it is replaced by a new one.

Since only one key need be operated, after which a plurality of steps are carried out automatically, that is to say the setting of the editing mark 23, the carrying out of the backward jump 24 and the switching to the replay mode 21, this allows considerably more convenient and reliable control. Since the backward jump takes place by a predetermined time period Δt, the position on switching to the replay mode is in the immediate vicinity of the point t1 at which the editing mark should optimally be set. This is a considerable advantage over manual operation of different keys, since it is not possible to accurately check during fast reverse how far away the position at which switching takes place to the replay mode occurs before the optimum position of the editing mark. The position is generally much too far forwards in the film, so that it takes a relatively long time before the user once again sees the start of the advertising block. Since a relatively long time passes, the user's attention will have already been diverted again, so that the editing mark will very probably be set too late on the second attempt as well.

The same method for setting an editing mark can also be used for the second editing mark, which identifies the end of the film section to be edited out. Any desired number of editing marks may be set within a film, with the procedure always being the same. The editing mark can also be used just as a marker for subsequent operations, initiated by the editing function. Examples of such operations are the setting of track marks on a movie recorded on a DVD, in and out fading of the sound track volume, and applying other sequence transition effects.

The keys for setting the first and the second editing marks are preferably different keys 13 and 14 on the remote control 2. It is advantageous to mark them with different colors, by way of example with the key for setting the first editing mark being red, and that for setting the second editing mark being green. This prevents the incorrect editing mark accidentally being set, with the wrong film section being deleted.

It is also advantageous for the display unit 3 to be used to indicate whether the film section currently being viewed is before the first editing mark, after the second editing mark or between the two editing marks. For example, it is advantageous to overlay a colored symbol, which is green when replay is before the first or after the second editing mark, and is red when replay is within the film section to be edited out between the two editing marks. It is also feasible for the film section that is to be edited out to be identified by a red frame or red shading.

FIG. 4 once again illustrates the procedure for setting the editing mark, clearly, in the form of a timing diagram. The point at which (in order to remain within the present example) the advertising block starts is annotated t1, and this is therefore the point at which the first editing mark should optimally be set. The delayed reaction of the user results in the editing mark actually being set at the time t1+x1, however. Once the key has been pressed and the editing mark has been set at the time t1+x1 an automatic backward jump is made by the time period Δt. This ends at the time t2, which may be before or after the desired time t1, depending on the delay and the selected time period Δt. The replay mode starts automatically at the time t2.

If the user finds that the current position is after the intended time t1, he can press the key once again in order to initiate a further backward jump, although this intermediate step is not illustrated explicitly in FIG. 4. This is associated with setting of an intermediate editing mark whose position is, however, not important since this mark is positioned after the time t1, too. This procedure may, of course, be repeated as often as desired in order to move the editing mark backward.

Once a backward jump has led to a current position which is before the time t1, the replay mode which follows this automatically leads to the user now seeing the time t1 for the second time. This example is based on the assumption that the reaction is once again delayed, this time to the time t1+x2. Setting of the editing mark this time is in fact better than the previous time, but is not yet satisfactorily close to the optimum position t1. The setting of the improved editing mark at the time t1+x2 once again results in an automatic backward jump, this time to the time t3. When the viewer once again sees the time t1, he presses the key at the time t1+x3. The editing mark is set at this time, and an automatic backward jump is made to the time t4, once again followed by switching to the replay mode. In this exemplary embodiment, the user is satisfied with the mark set at the time t1+x3, so that this completes the process of setting the first editing mark.

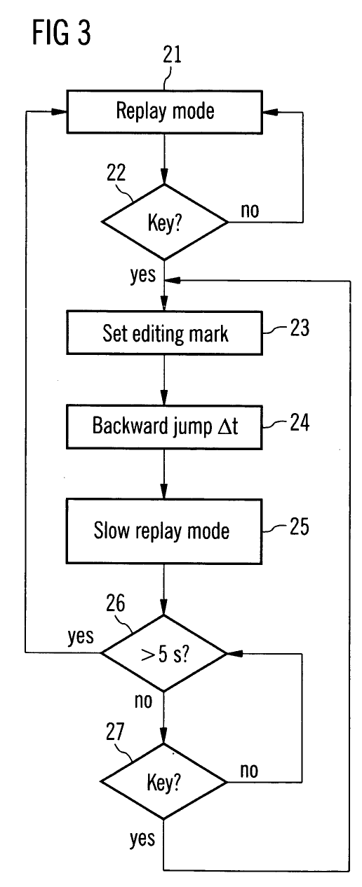

In an improved embodiment shown in the flowchart in FIG. 3, the replay mode is carried out in a slowed-down variant once the backward jump has been carried out. This makes it easier for the user to find the optimum position for pressing the key and for setting the editing mark. This is illustrated in the flowchart by a slowed-down replay mode (step 25) being selected after the backward jump by the time period Δt in step 24. If the key for setting the editing mark is not pressed (steps 26 and 27), the slow replay mode is maintained, in this exemplary case, for 5 seconds. The pressing of the key for setting the editing mark (step 27) leads to a backward jump, with another editing mark being set by step 23. If the key for setting the editing mark is not pressed within the time period of 5 seconds (step 26), then the process switches via step 21 to the normal replay mode.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

I claim:

1. A method for editing a digital film using an electronic data processing apparatus, comprising the steps of:
setting a first editing mark;
setting a second editing mark; and
deleting a film section between the first editing mark and the second editing mark;
wherein at least one of said steps of setting the first and second editing marks comprises the following steps performed in sequence by the electronic data processing apparatus:
(a) during a replay mode, responding to manual actuation of a key by setting the editing mark at a first point on the digital film;
(b) automatically making a backward jump (24) from said first point on the digital film to a first earlier point on the digital film;
(c) automatically initiating a continuation of the replay mode at said first earlier point on the film reached by said backward jump; and
(d) in response to another manual actuation of the key, which is made when said first point is at an unsatisfactory location on the digital film, setting the editing mark at a second point on the digital film during continuation of the replay mode.

2. The method according to claim 1,
wherein the following steps are carried out automatically, in response to said other manual actuation of the key:
(a) deleting said editing mark at said first point on the digital film;
(b) making a backward jump (24) from said second point on the digital film to a second earlier point on the digital film; and
(c) initiating a continuation of the replay mode at said second earlier point on the digital film reached by said backward jump.

3. The method according to claim 1,
wherein in step (c) the replay mode is continued in a slowed-down variant (25) after said backward jump.

4. The method according to claim 3, further comprising automatically switching back to a normal replay variant (21) from said slowed-down replay variant (25) after a predetermined period of time.

5. The method according to claim 1, wherein said steps (a), (b) (c) and (d) are performed on setting said first and second editing marks, with the setting of said first editing mark being initiated by operation of a first key (13), and the setting of the second editing mark being initiated by operation of a second key (14).

6. The method according to claim 5, wherein the first and the second keys (13, 14) are operated on a remote control (2) for the electronic editing apparatus.

7. The method according to claim 1, wherein a display unit (3) indicates whether the currently running film section is before the first editing mark, after the second editing mark, or between the two editing marks.

8. Editing apparatus for editing of a digital film having a data processing apparatus (1) and a remote control (2), wherein the data processing apparatus (1) or the remote control (2) is adapted to perform the method according to claim 1, and the key (13, 14) is a key on the remote control (2).

9. A method for accurately setting an editing mark on a digital film using an electronic data processing apparatus, comprising the following steps performed in sequence by the electronic data processing apparatus:
(a) during a replay mode, responding to manual actuation of a key by setting the editing mark at a first point on the digital film;
(b) automatically making a backward jump (24) from said first point on the digital film to a first earlier point on the digital film;
(c) automatically initiating a continuation of the replay mode at said first earlier point on the film reached by said backward jump; and
(d) in response to another manual actuation of the key, which is made when said first point is at an unsatisfactory location on the digital film, setting the editing mark at a second point on the digital film during continuation of the replay mode.
